(19) United States
(12) Patent Application Publication
(10) Pub. No.: US 2014/0269812 A1
(43) Pub. Date: Sep. 18, 2014

(54) Method and Apparatus for Probe Calibration

(71) Applicant: Primex Wireless, Inc., Lake Geneva, WI (US)

(72) Inventors: Stephen Deutscher, Burlington, WI (US); Paul Shekoski, Crystal Lake, IL (US)

(73) Assignee: Primex Wireless, Inc, Lake Geneva, WI (US)

(21) Appl. No.: 14/213,283

(22) Filed: Mar. 14, 2014

Related U.S. Application Data
(60) Provisional application No. 61/784,070, filed on Mar. 14, 2013.

(51) Int. Cl. G01K 15/00

(52) U.S. Cl. CPC G01K 15/005
USPC 374/1

(57) ABSTRACT

A temperature probe for determining a calibrated temperature value is described. The temperature probe includes a sensing element, a memory, and a probe communication interface. The sensing element provides a measured value corresponding to a temperature of the temperature probe. The memory stores calibration data from a calibration procedure performed on the temperature probe. The probe communication interface outputs the measured value and the calibration data for determination of the calibrated temperature value.

### CROSS-REFERENCE TO RELATED APPLICATIONS

The present application claims priority to U.S. Provisional Patent Application 61/784,070, filed Mar. 14, 2013, the content of which is hereby incorporated by reference herein.

### TECHNICAL FIELD

The present disclosure is related generally to temperature monitoring systems and, more particularly, to calibration of temperature probes.

### BACKGROUND

In healthcare and food services industries, there are safety regulations for monitoring refrigerators and freezers to ensure storage at a proper temperature for vaccines, medication, blood and tissue, and food products. The monitoring can be accomplished by using a sensor monitoring system employing detachable temperature probes. The temperature probes connect into a sensor device (or data logger) that provides a voltage (or current) source to the temperature probe. The temperature probe then provides a resistance value (e.g., in ohms) to the sensor device based on the temperature of the medium in which the temperature probe is inserted.

The sensor device reads the resistance value and converts the resistance value into a temperature value. The sensor device may convert the resistance value by accessing a look-up table or derivation via an algorithm (e.g., interpolation). The temperature is then stored in the sensor or sent via a wired or wireless connection to a software management program residing on a server for storage or further processing. However, the resistance values for a given temperature may differ between temperature probes and vary over time due to manufacturing variations, deterioration of internal components, corrosion, or other conditions. Each temperature probe must be calibrated and tracked for accurate measurement of temperatures.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a block diagram illustrating a sensor monitoring system, according to an embodiment;

FIG. 2A is a partial perspective view of a plug for a probe of the sensor monitoring system of FIG. 1, according to an embodiment;

FIG. 2B is another partial perspective view of the plug for the probe of FIG. 2A, illustrating a housing for the plug;

FIG. 3 is a table of adjustment values that may be used by the sensor device of the sensor monitoring system of FIG. 1, according to an embodiment;

FIG. 4 is a table of adjustment values that may be used by the sensor device of the sensor monitoring system of FIG. 1, according to an embodiment;

FIG. 5 is a flowchart of a method for determining calibrated temperature values that may be performed by a sensor device of the sensor monitoring system of FIG. 1, according to an embodiment.

FIG. 6 is a partial perspective view of a probe of the sensor monitoring system of FIG. 1, according to another embodiment;

FIG. 7 is another partial perspective view of a plug for the probe of FIG. 6, illustrating a housing for the plug;

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

The present disclosure describes methods and apparatuses that provide a calibrated temperature value for a temperature probe. According to various embodiments, calibration data is stored on a memory of a temperature probe. The calibration data may include one or more of a unique identification of the probe, a calibration date of a calibration procedure for the probe, a probe type, or a plurality of deviation values for the temperature probe. A sensor device receives the calibration data from the temperature probe. The sensor device determines a measured value from the temperature probe and determines a calibrated temperature value based on the measured value and the deviation values. The sensor device provides a more accurate calibrated temperature value by using the deviation values.

According to an embodiment, calibration data is received from a temperature probe connected to the sensor device. A measured value from the temperature probe is determined, which corresponds to a temperature of the temperature probe. A calibrated temperature value for the temperature probe is determined based on the measured value and the calibration data.

Turning to FIG. 1, a sensor monitoring system 100 includes a sensor device 120, a probe 110, and a sensor manager 130. The probe 110, sensor device 120, and sensor manager 130 monitor temperature associated with an asset 140. Examples of the asset 140 include refrigerators and freezers (e.g., a refrigerated asset) that contain materials such as vaccines, medication, blood and tissue samples, or food products. In this case, a user or owner of the asset 140 may desire that the asset 140 be maintained at a refrigerated temperature or within a predetermined temperature range. In other embodiments, the asset 140 is the material itself (i.e., the probe 110 monitors the temperature of the vaccine, medication, etc.). The asset 140 may be any other asset or item that is to be maintained at or within a temperature range. While the description herein relates to monitoring temperature of the asset 140, other measurable characteristics associated with the asset 140 may be monitored in alternative embodiments.

The probe 110 in one example is a temperature probe. Possible implementations of the probe 110 include a resistance temperature detector (“RTD”), thermistor, or thermocouple device. The probe 110 includes a memory 111, a sensing element 112, and a communication interface 113. The memory 111 is a re-writeable or programmable memory. The memory 111 stores calibration data for the probe 110, as described herein. The sensing element 112 provides a measured value corresponding to a temperature of the probe 110 to the sensor device 120 via the communication interface. The sensing element 112 in one example is a resistive element for an RTD or thermistor, thus the measured value is a resistance value (e.g., measured in Ohms). In other embodiments, the measured value may be a voltage (e.g., for a thermocouple device) or other measurable characteristic. The communication interface 113 in one example is a wired electrical connector, plug, or receptacle (e.g., a tip/sleeve or tip/ring/ring/sleeve style plug, such as a 3.5 mm audio cable interface). In other embodiments, the communication interface 113 is a wireless communication interface, such as Bluetooth (e.g., ultra-low power or low energy Bluetooth), Zigbee, or other wireless communication interface.

As illustrated in FIG. 1, the sensing element 112 is located remotely from the communication interface 113. The probe 110 includes a communication link 114 (e.g., a wire or cable) that communicatively couples the sensing element 112 with the communication interface 113 (e.g., an electrical plug). In this case, the memory 111 is located within a housing of the electrical plug (i.e., in the communication interface 113) and is thus remotely located from the asset 140.

The sensor device 120 includes a memory 121, a processor 122, and a communication interface 123. The memory 121 is a re-writeable or programmable memory. The processor 122 executes programs or algorithms stored in the memory 121. The probe 110 provides the measured value to the sensor device 120 based on a temperature of the medium in which the probe 110 has been inserted or is located (e.g., a temperature of the asset 140). The sensor device 120 determines a temperature value by converting the measured value received from the probe 110. Optionally, the sensor device 120 performs interpolation to determine the temperature value. In one example, the sensor device 120 performs a lookup in a temperature table which is stored in the memory 121 for the conversion. In another example, the processor 122 executes a conversion algorithm stored in the memory 121 for the conversion. The sensor device 120 may also perform a data logging function by storing data over time, such as the measured values, temperature values, or other data. The sensor device 120 may also send data to the sensor manager 130, such as the measured value, temperature value, or notifications, as described herein.

The temperature table for conversion of the measured value to the temperature value in one example is a resistance-to-temperature look-up table. The sensor device 120 in one example modifies the temperature table when calibration data is received from the probe 110. For example, the sensor device 120 adds an offset or calibration factor to an entry in the temperature table based on a deviation value corresponding to a temperature reference point of the calibration data. This offset, when added to (or subtracted from) the temperature value in the temperature table, helps to increase accuracy of the conversion and thus the temperature value by reducing the error introduced by the probe 110 not being ideal (e.g., due to manufacturing tolerances).

The communication interface 123 in one example is a wired electrical connector, plug, or receptacle (e.g., a tip/sleeve style receptacle) that, upon engagement or attachment with the interface 113, communicatively couples the sensing element 112 with the sensor device 120 for determining the measured value. In other embodiments, the communication interface 123 is a wireless communication interface, such as Bluetooth, Zigbee, or other wireless communication interface that is compatible with the communication interface 113. The sensor device 120 sends data to the sensor manager 130 via the communication interface 123. While only one communication interface 123 is shown, in alternative embodiments the sensor device 120 includes multiple communication interfaces, for example, to communicate with multiple probes or sensor managers.

The sensor manager 130 includes a memory 131, and a processor 132 that executes programs stored in the memory 131. The processor 132 writes data to and reads data from the memory 131. The sensor manager 130 includes a communication interface 133, such as a wired electrical connector, plug, or receptacle or wireless communication interface for communication with the sensor device 120 via the communication interface 123. While only one communication interface 133 is shown, in alternative embodiments the sensor manager 120 includes multiple communication interfaces, for example, to communicate with multiple probes or other sensor managers.

The sensor manager 130 may further include a database 134 that stores temperature tables, calibration reports or data, temperature values, measured values, predetermined temperature ranges, or other data. The sensor manager 130 in one example uses a server-based software management program to store and manipulate temperature values received from the sensor device 120 and probe 110. The sensor manager 130 in one example monitors temperature values and compares user-defined high and low temperature thresholds associated with the asset 140. In other embodiments, the sensor manager 130 is implemented on a personal computer or other computing device.

Turning to FIG. 2A and FIG. 2B, a plug 200 illustrates one example of the communication interface 113 of the probe 110, according to an embodiment. The plug 200 includes a memory 211, a tip/sleeve electrical connector 213, a communication link 214, and a housing 215. The memory 211 stores the calibration data for the probe 110. The tip/sleeve electrical connector 213 engages the communication interface 123 of the sensor device 120. The communication link 214 provides an electrical connection to the sensing element 112. The housing 215 covers and protects the memory 211. The housing 215 may be removably attached to the plug 200 by a threaded interface 216.

Turning to FIG. 6 and FIG. 7, a probe 600 illustrates another embodiment of the probe 110. The probe 600 includes a sensing element 612, a memory 611, a tip/ring/ring/sleeve electrical connector 613, a communication link 614, and a housing 615. The memory 611 stores the calibration data for the probe 600. The electrical connector 613 engages the communication interface 123 of the sensor device 120. The communication link 614 provides an electrical connection to the sensing element 612. The housing 615 covers and protects the memory 611. The housing 615 may be removably attached to the electrical connector 613 by a threaded interface 616.

Turning to FIG. 3, a table 300 illustrates one example of calibration data for a temperature probe. To measure or test the accuracy of temperature probes, the probes may be sent to a laboratory, such as a National Institute of Standards and Technology (“NIST”) or International Organization for Standards/International Electrotechnical Commission (“ISO/IEC”) 17025 certified laboratory. The laboratory typically tests the probe at a plurality of known calibration temperature reference values (e.g., different test points). Based on data from the tests, a table such as the table 300 may be generated with actual measured values or readings (e.g., resistance or temperature values) measured from the probe under test versus the calibration temperature reference value. However, the data may be provided in other data formats and is not limited to a table format. The laboratory may provide a calibration data report showing a unique identification of the probe (e.g., a probe serial number) and the calibration temperature reference values versus the actual measured values. The data or report includes a deviation value (e.g., a difference between the actual measured value and the calibration temperature reference value) introduced by the probe.

Turning to FIG. 4, a table 400 illustrates one example of a calibration report for a 100 Ohm platinum RTD probe. In this case, the plurality of calibration temperature reference values 402 includes {36, 37, 38 . . . 46} degrees Fahrenheit, which is a typical temperature range for vaccine storage. Other temperature ranges for assets will be apparent to those skilled in the art. A temperature table of the probe in this example includes a plurality of default measured values 404 that correspond to a plurality of temperature values 406 {36, 37, 38, . . . 46} degrees Fahrenheit. The default measured values 404 and temperature values 406 in one example are based on a temperature table provided by a manufacturer of the probe 110 (e.g., a default temperature table). The calibration report includes actual measured values 408 for the probe at the calibration temperature reference values 402. A deviation value is a difference between the resistance in the measured values 404 of the lookup table and the actual measured values 408. A plurality of deviation values 410 correspond to the plurality of calibration temperature reference values 402.

The memory 111 of the probe 110 stores calibration data from the calibration report and the unique identification of the probe 110. Thus, a history of calibration data may be tracked and managed for individual probes (e.g., using the sensor manager 130). After the sensor device 120 receives the calibration data from the memory 111 of the probe 110, the sensor device 120 updates the temperature table to reflect the actual measured values for the probe 110. Where a plurality of probes is connected to the sensor device 120, the sensor device 120 updates a temperature table for each of the plurality of probes. If a probe with a different unique identification is inserted or if the calibration data for a probe has changed, the sensor device 120 updates the temperature table with the deviation values for that probe.

While general characteristics of a probe may be known, the deviation between reference (e.g., default) values and actual values must either be tracked and accounted for manually or built into a published “worst case” tolerance level of a measurement system. Tolerances of the system (±temperatures) are often larger than need be to accommodate for variations between probes. The probe 110 stores calibration data so that the sensor device 120 may account for deviations of an individual probe.

Turning to FIG. 5, a flowchart 500 illustrates an embodiment of a method for determining calibrated temperature values that may be performed by the sensor device 120. The sensor device 120 communicatively couples (505) with the probe 110, for example, a user may insert an electrical plug (e.g., the communication interface 113) into an electrical receptacle of the sensor device 120 (e.g., the communication interface 123). Upon insertion, the sensor device 120 determines (510) whether the probe 110 has a memory with calibration data. If the probe 110 does not have a memory 111 or if the memory 111 is not recognized (NO at 510), the sensor device 120 uses the default temperature table. The sensor device 120 then determines (515) a measured value for the probe 110, for example, by reading the measured value from the sensing element 112 via the communication interfaces 113 and 123. The sensor device 120 generates (520) a temperature value that corresponds to the measured value. As described above, the sensor device 120 may perform a lookup in the default temperature table with the measured value. Alternatively, the sensor device 120 may derive the temperature value with the conversion algorithm based on the measured value and at least one deviation value. The sensor device 120 may store the temperature value, send the temperature value to the sensor manager 130, or both.

If the probe 110 has a memory 111 (YES at 510), the sensor device 120 receives (525) calibration data from the probe 110. For example, the sensor device 120 reads one or more of a unique identification of the probe, a calibration date of a calibration procedure for the probe, a probe type or model indication, a calibration date, or a plurality of deviation values and corresponding calibration temperature reference values for the probe 110. The sensor device 120 in one example reads the memory 111 using a “bit bang” protocol. In this case, the interfaces 113 and 123 may provide a one-wire bus interface as a separate pin of the interface 113 (e.g., a tip pin of a tip, ring, sleeve interface) for access to the memory 111, thus readings for the measured values are obtained separately from readings for the calibration data. The sensor device 120 in one example reads the calibration data only when the interface 113 is initially detected (e.g., upon cable insertion).

The sensor device 120 optionally sends (530) data to the sensor manager 130. For example, the sensor device 120 sends one or more of the unique identification, the probe type, model indication, a most recent calibration date, or a probe service date to the sensor manager 130. The sensor manager 130 may use the data to assign the unique identification to the asset 140 and provide calibration notifications to a user. The sensor device 120 may also send the calibration data to the sensor manager 130 for generation of a calibration certification report for the temperature probe.

In another example, the sensor device 120 sends temperature notifications (e.g., alerts or alarms) to the sensor manager 130 when the temperature value is outside an acceptable range or meets a predetermined threshold. The sensor device 120 may also provide a notification if the calibrated temperature value exceeds a specification limit of the temperature probe based on the probe type. This notification may reduce attempts to improperly use probe, such as using a standard range temperature probe in a deep cold cryogenic freezer. The sensor device 120 may also flag stored values (measured values or temperature values) that are outside the acceptable range. The temperature values may also be used by the sensor device 120 or sensor manager 130 for electronic reports for auditing bodies to ensure vaccines or medications are stored at proper temperatures and that corrective actions occur if the thresholds are exceeded.

The sensor device 120 optionally provides (535) one or more calibration notifications for the probe 110. For example, the sensor device 120 provides a calibration notification for a next calibration procedure of the probe based on the calibration date. The sensor device 120 may also store the probe service date on which the probe 110 is put into service and provide the calibration notification based on the probe service date (e.g., a duration of service for the probe 110).

The sensor device 120 automatically modifies (540) the temperature table based on the calibration data (e.g., upon insertion of the probe 110). For example, the sensor device 120 modifies the default measured values 404 of the temperature table 400 with the corresponding plurality of deviation values 410. The sensor device 120 may modify an existing temperature table or create a new temperature table (e.g., to allow for future modifications relative to the default measured values). In some embodiments, the sensor device 120 uses only a portion of the plurality of deviation values. In this case, the sensor device 120 modifies the temperature table using only deviation values of the plurality of deviation values that correspond to a predetermined temperature range. For example, if a user is interested in calibration of a probe for a temperature range associated with medical vaccine storage—typically 2 to 8° C.—the plurality of deviation values and corresponding calibration temperature reference values may be concentrated in this range or only those deviation values within the range may be used when modifying the temperature table.

After modification (540) of the temperature table, the sensor device 120 determines (515) the measured value for the probe 110. The sensor device 120 generates (520) the temperature value for the probe 110 using the modified temperature table. Thus, the sensor device 120 automatically determines the calibrated temperature value based on a lookup in the modified temperature table with the measured value from the probe 110. In other embodiments, the sensor device 120 determines the temperature value and then applies the deviation value to determine or derive the calibrated temperature value.

When new probes are coupled with the sensor device 120 or when probes are recertified, the probes may have different deviation values. In this case, the sensor device 120 performs the method of FIG. 5 again. For example, where a probe is recertified, a second plurality of deviation values with a most recent calibration date may be received which correspond to a second calibration procedure performed on the probe 110. The sensor device 120 receives and stores the most recent calibration date and the second plurality of deviation values in the memory 111 of the probe 110. In some cases, only deviation values of the second plurality of deviation values that correspond to a predetermined temperature range are stored.

While the temperature table has been described herein as being stored on the sensor device 120, in other embodiments the temperature table is stored in the sensor manager 130. The temperature table modification could be performed in other elements with sufficient processing power and access to the calibration data stored in the memory 111. Various steps may be performed by the sensor manager 130 instead of, or in combination with, the sensor device 120, such as steps 515, 520, 525, 535, or 540.

It can be seen from the foregoing that methods and apparatuses for providing a calibrated temperature value for a temperature probe have been described. In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

The apparatus described herein may include a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

The disclosed embodiments may be described in terms of functional block components and various processing steps. Such functional blocks may be realized by any number of hardware and/or software components configured to perform the specified functions. For example, the disclosed embodiments may employ various integrated circuit components, e.g., memory elements, processing elements, logic elements, look-up tables, and the like, which may carry out a variety of functions under the control of one or more microprocessors or other control devices. Similarly, where the elements of the disclosed embodiments are implemented using software programming or software elements, the disclosed embodiments may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the disclosed embodiments may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, “device”, “controller”, and “construction” are used broadly and are not limited to mechanical or physical embodiments, but may include software routines in conjunction with processors, etc.

No item or component is essential to the practice of the disclosed embodiments unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the disclosed embodiments (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

The use of any and all examples, or exemplary language (e.g., “such as”) provided herein, is intended merely to better illuminate the disclosed embodiments and does not pose a limitation on the scope of the disclosed embodiments unless otherwise claimed. Numerous modifications and adaptations will be readily apparent to those of ordinary skill in this art.

We claim:

1. A temperature probe for determining a calibrated temperature value, comprising:
a sensing element that provides a measured value corresponding to a temperature of the temperature probe;
a memory that stores calibration data from a calibration procedure performed on the temperature probe; and
a probe communication interface that outputs the measured value and the calibration data for determination of the calibrated temperature value.

2. The temperature probe of claim 1, wherein the calibration data includes a calibration date of the calibration procedure and a plurality of deviation values that corresponds to a plurality of calibration temperature reference values.

3. A temperature monitoring system for determining a calibrated temperature value, the system comprising:
a sensor device;
a temperature probe that comprises a memory that stores calibration data from a calibration procedure performed on the temperature probe and provides the sensor device with the calibration data and a measured value corresponding to a temperature of the temperature probe; and
wherein the sensor device determines the calibrated temperature value for the temperature probe based on the measured value and the calibration data.

4. The temperature monitoring system of claim 3, wherein the sensor device stores a temperature table for determination of the calibrated temperature value, modifies the temperature table based on a plurality of deviation values of the calibration data, and determines the calibrated temperature value based on a lookup in the modified temperature table with the measured value.

5. The temperature monitoring system of claim 3, wherein the sensor device performs a conversion algorithm based on the measured value and the at least one deviation value of the plurality of deviation values to determine the calibrated temperature value.

6. The temperature monitoring system of claim 3, wherein the calibration data includes a probe service date of the temperature probe and the sensor device provides a calibration notification for a next calibration procedure of the temperature probe based on the probe service date.

7. The temperature monitoring system of claim 3, further comprising a sensor manager that receives calibration data from the temperature probe and generates a calibration certification report for the temperature probe based on the calibration data.

8. The temperature monitoring system of claim 3, wherein the probe communication interface comprises a wired electrical connector, the memory is located within the wired electrical connector, and the sensor device receives the calibration data from the memory of the temperature probe upon connection of the wired electrical connector of the temperature probe to the sensor device.

9. The temperature monitoring system of claim 3, wherein the probe communication interface comprises a wireless communication interface.

10. A method for determining a calibrated temperature value for a temperature probe, the method comprising:
receiving calibration data from the temperature probe;
determining a measured value from the temperature probe that corresponds to a temperature of the temperature probe;
generating a calibrated temperature value based on the measured value and the calibration data.

11. The method of claim 10, wherein receiving the calibration data comprises reading the calibration data from a memory of the temperature probe.

12. The method of claim 11, wherein the calibration data includes a plurality of deviation values that corresponds to a plurality of calibration temperature reference values, the method further comprising modifying a temperature table of a sensor device based on the plurality of deviation values;
wherein generating the calibrated temperature value comprises determining the calibrated temperature value based on a lookup in the modified temperature table with the measured value from the temperature probe.

13. The method of claim 12, wherein modifying the temperature table comprises modifying the temperature table using only deviation values of the plurality of deviation values that corresponds to a predetermined temperature range.

14. The method of claim 11, wherein the calibration data includes a plurality of deviation values that corresponds to a plurality of calibration temperature reference values, wherein generating the calibrated temperature value comprises deriving the calibrated temperature value with a conversion algorithm based on the measured value from the temperature probe and at least one deviation value of the plurality of deviation values.

15. The method of claim 11, wherein the calibration data includes a calibration date of a most recent calibration procedure performed on the temperature probe;
the method further comprising providing a calibration notification for a next calibration procedure of the temperature probe based on the calibration date.

16. The method of claim 11, wherein the calibration data includes a probe type of the temperature probe, the method further comprising providing a notification if the calibrated temperature value exceeds a specification limit of the temperature probe based on the probe type.

17. The method of claim 11, wherein the calibration data includes a first plurality of deviation values that corresponds to a first plurality of calibration temperature reference values of a first calibration procedure performed on the temperature probe, the method further comprising:
storing, in the memory of the temperature probe, a second plurality of deviation values that corresponds to a second plurality of calibration temperature reference values of a second calibration procedure performed on the temperature probe.

18. The method of claim 17, wherein storing the second plurality of deviation values comprises storing only deviation values of the second plurality of deviation values that correspond to a predetermined temperature range.

19. The method of claim 17, further comprising storing a calibration date of the second calibration procedure in the memory of the temperature probe.
